(19) United States
(12) Patent Application Publication
(10) Pub. No.: US 2012/0131385 A1
(43) Pub. Date: May 24, 2012

(54) TESTING MEHTOD FOR UNIT UNDER TEST

(75) Inventors: CHIH-JEN CHIN, Taipei (TW); Lien-Feng Chen, Taipei (TW)

(73) Assignee: INVENTEC CORPORATION, Taipei (TW)

(21) Appl. No.: 12/981,190

(22) Filed: Dec. 29, 2010

(30) Foreign Application Priority Data
Nov. 19, 2010 (TW) 099139984

(51) Int. Cl. G06F 11/26

(52) U.S. Cl. 714/32; 714/E11.159

(57) ABSTRACT

A testing method for a unit under test is provided. At least one unit under test is electrically connected to a testing machine. The testing machine creates a test script and executes the test script, so as to perform a non-operating system (OS) test and an OS test on the unit under test, and the testing machine is capable of combining the testing results, so a testing process is simplified, a test time is shortened, and test accuracy is improved.

### BACKGROUND OF THE INVENTION

1. Field of Invention

The present invention relates to a testing method for a unit under test. According to the testing method, a unit under test such as a circuit board or a main board is in an empty board state, and a non-operating system (OS) test and an OS test are performed, two testing results are combined, so a test time is shortened, a testing process is simplified, and test accuracy is improved.

2. Related Art

A main board is an important execution component in a computer, and is electrically connected to various electronic components such as a hard disk, a link port, and a power supply, so the computer cannot work without the main board.

Before being started, the main board will perform an initialization action by using the basic input/output system (BIOS) stored in a flash memory or the electrically-erasable programmable read-only memory (EEPROM). In this action, memories and peripheral devices are tested and initially set, and such a process is generally called as a power on self test (POST). If an error occurs during POST, the main board makes a sound or display the error on the screen.

The POST is performed after the main board is assembled in the computer, while most main boards are detected by the manufacturer at the factory, so as to determine whether the main board has damages before being assembled in the computer.

Three tests are performed on the main board, that is, POST, an OS test, and visual observation, at this time, no electronic component such as a hard disk, a CPU, or a memory is connected to or disposed on the main board, and the main board is only provided with relevant circuits, so the main board is referred to as an empty board in the industry.

In the POST test, the empty board is connected to a testing machine to perform the POST test on the empty board.

In the OS test, the empty board is connected to another testing machine, and the testing machine is provided with a relevant OS, so as to perform the OS test on the empty board. Additionally, the OS test also another mode, in which some manufacturers divide the empty board into several areas, so as to perform the test with a probe, thus detecting whether the area is capable of normal operation.

In visual observation, whether sockets of the empty board are damaged or whether the connection between the sockets and the empty board is desirable is observed with eyes.

In view of the above, the current testing methods for the empty board need to perform the tests in stages, and the data collected in the tests cannot be integrated, so the test is a multi-segment test for a tester, and the procedure is complicated and time consuming. Furthermore, determining the states of the sockets with eyes are not accurate. Therefore, the current test methods need to be improved.

### SUMMARY OF THE INVENTION

In view of the above disadvantages, the present invention is directed to a testing method for a unit under test, in which a non-OS test and an OS test are performed on the unit under test such as a circuit board or a main board in an empty board state, and two testing results are combined, thus reducing the test time and improving test accuracy.

In order to achieve the objective, a technical solution of the present invention is to provide a testing method for a unit under test, which comprises the following steps.

I) Scanning and downloading: a testing machine scans information of at least one unit under test, and creates a test script, and the test script is downloaded into the unit under test.

II) Starting the unit under test: a script engine executes a non-OS test, generates a testing result of the non-OS test, and transfers the testing result of the non-OS test to the testing machine.

III) Executing an OS test on the unit under test: the script engine executes an OS test on the unit under test according to the test script, generates a testing result of the OS test, and transfers the testing result of the OS test to the testing machine.

IV) Combining the testing results: the testing machine combines the testing result of the non-OS test and the testing result of the OS test.

V) Displaying the testing result: an operation machine displays the combined testing result.

In Step I, the testing machine scans the information of the unit under test, a script editor disposed in the testing machine creates a test script of a command-line interface (CLI) according to the scanned information, the test script is downloaded into the unit under test through a unit under test link port (UUT-link port), and a software control (SFC) receives the downloading result of the unit under test, and records and checks the downloading result.

Before Step I, a step of providing an initial standby power supply is further comprised, in which the at least one unit under test is electrically connected to a connection interface of the testing machine.

The unit under test is a main board or a circuit board. The testing machine is a console computer or an ITCnD CLI. The connection interface has a general purpose input output (GPIO), a network interface card (NIC), a UUT-link port, and a display interface. The GPIO is applicable in a joint test action group (JTAG), an inter-integrated circuit (IIC), or a serial peripheral interface bus (SPI), in which the GPIO is electrically connected to at least one test board and at least one detection board, the test board is electrically connected to the unit under test, and the detection board is electrically connected to a socket of the unit under test. The detection board is a debug card or a dummy card. The NIC is applicable in the Simple Network Management Protocol (SNMP), the Intelligent Platform Management Interface (IPMI), or the Telnet. The NIC and the UUT-link port are electrically connected to the unit under test, the unit under test has a display screen, and the display screen is electrically connected to the display interface.

Between Step I and Step II, a step of starting the test board is comprised, in which the testing machine starts the test board, the test board burns a BIOS into the unit under test, and the script engine disposed in the testing machine executes the test script through the test board.

Between Step III and the step of starting the test board, a step of Basic Local Alignment Search Tool (BLAST) or authentication of programmable parts is further comprised, in which the test board starts to program parts of the unit under test and performs BLAST or authentication on the parts.

The non-OS test in Step II comprises the following contents.

A) POST: the test board performs a BIOS test on the unit under test.

B) A complex programmable logic device (CPLD) diagnosis: the detection card detects logic, output, and input states of the socket.

C) Power debug checking: the detection card performs error check on the power supply of the unit under test, and if an error is found in the power supply of the unit under test, a debug action is performed.

D) Relevant signal measurement and check: the detection card performs signal measurement on the parts of the unit under test, and transfers a measurement signal to the display screen, so as to check whether damages or error signals occur.

E) Obtaining a state of the test script at the testing machine: the test board makes the unit under test to be in an OS state, and downloads another test script into the unit under test.

F) A function test or a power cycle: the detection board performs a function test or a power cycle on the unit under test according to the test script in Step E.

G) Uploading a result to the testing machine: the testing result is first displayed on the display screen of the unit under test, and then is sent back to the testing machine through the display screen.

In Step B to Step D, the detection board tests whether the socket is damaged or whether the connection between the socket and the unit under test is desirable, or performs a debug action.

In Step III, the testing machine provides an OS to the unit under test through the test board, and the OS is WIN, DOS, Linux, or EFI.

In Step V, the combined testing result in Step IV is displayed in a report form.

In view of the above, according to the testing method for a unit under test of the present invention, at least one unit under test is electrically connected to a testing machine, and a script editor of the testing machine creates a test script, a script engine performs a non-OS test and an OS test on the unit under test according to the test script, and the testing machine combines the two testing results, and thus the test time is shortened, the testing process is simplified, and the test accuracy is improved.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a unit under test to a testing machine in a testing method for a unit under test according to the present invention; and

FIG. 2 is a flow chart of a testing method for a unit under test according to the present invention.

### DETAILED DESCRIPTION OF THE INVENTION

The implementation of the present invention will be described in detail with reference to the following specific embodiments, and those skilled in the art can easily understand other advantages and efficacies of the present invention with reference to the content disclosed in the specification.

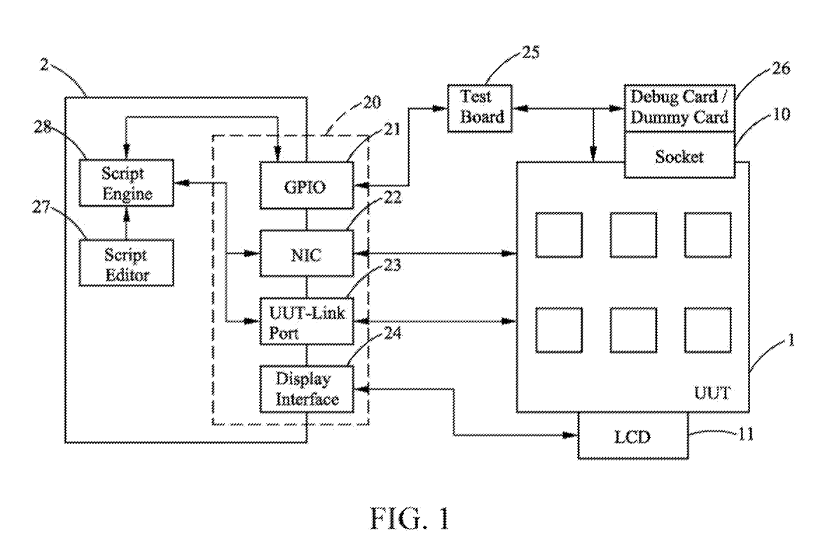

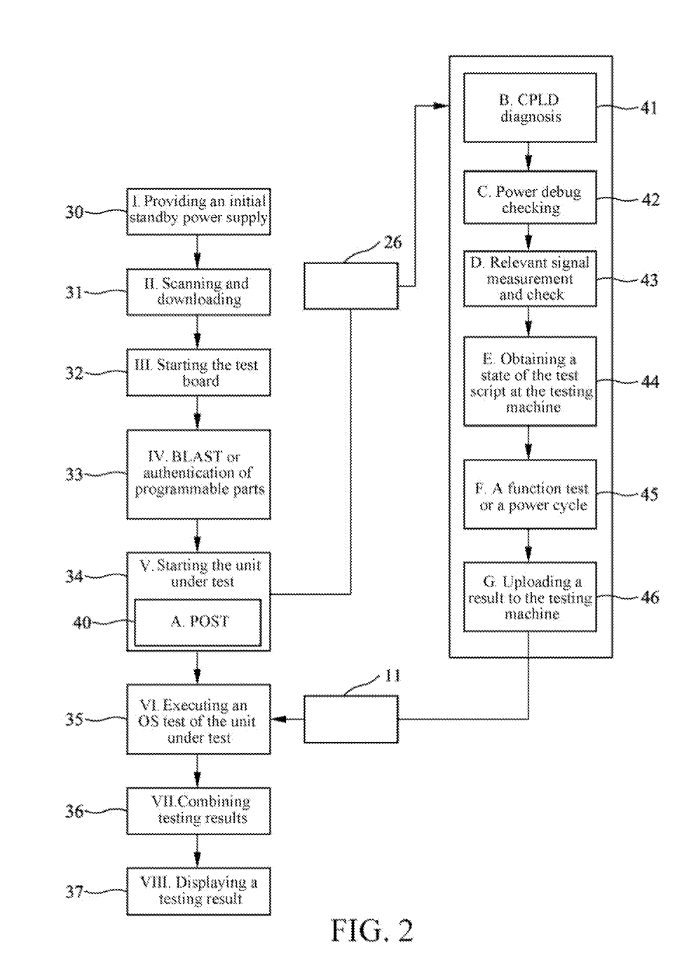

Referring to FIG. 1 and FIG. 2, a testing method for a unit under test according to the present invention includes the following steps.

1) Providing an initial standby power supply 30: a standby power supply is provided for at least one unit under test 1, and the connection manner is described in detail as follows.

The at least one unit under test 1 and a testing machine 2 are electrically connected to each other, the unit under test 1 may be a main board or a circuit board. The testing machine 2 may be a console computer or an ITCnD CLI. The testing machine 2 has a connection interface 20. The connection interface 20 has a GPIO 21, an NIC 22, a UUT-link port 23, and a display interface 24.

The GPIO 21 is applicable in a JTAG, an IIC, or an SPI, the GPIO 21 is electrically connected to at least one test board 25 and at least one detection board 26, the test board 25 is electrically connected to the unit under test 1, and the detection board 26 is electrically connected to a socket 10 of the unit under test 1.

The detection board 26 may be a debug card or a dummy card.

The NIC 22 is applicable in the Simple Network Management Protocol (SNMP), the Intelligent Platform Management Interface (IPMI), or the Telnet.

The NIC 22 and the UUT-link port 23 are electrically connected to the unit under test 1, the unit under test 1 is electrically connected to a display screen 11, and the display screen 11 is electrically connected to the display interface 24.

2) Scanning and downloading 31: The testing machine 2 scans information of the unit under test 1, a script editor 27 in the testing machine 2 creates a test script of a CLI according to the scanned information, the test script is downloaded into the unit under test 1 through the UUT-link port 23, and an SFC receives the downloading result of the unit under test 1, and records and checks the downloading result.

3) Starting the test board 32: the testing machine 1 starts the test board 25, the test board 25 burns a BIOS into the unit under test 1, and the script engine 28 disposed in the testing machine 2 executes the test script through the test board 25.

4) BLAST or authentication of programmable parts 33: the test board 25 starts to program parts of the unit under test, and performs BLAST or authentication on the parts.

5) Starting the unit under test 34: the unit under test 1 is started, such that the unit under test 1 executes a non-OS test, and such an action is described in detail as follows.

The step of Non-OS test includes the following contents.

A) POST 40: the testing machine 2 performs a BIOS test on the unit under test 1 through the test board 25.

B) A complex programmable logic device (CPLD) diagnosis 41: the testing machine 2 performs logic, output, and input states of the socket 10 through the detection card 26.

C) Power debug checking 42: the detection card 26 performs error check on the power supply of the unit under test 1, and if an error is found in the power supply of the unit under test 1, a debug action is performed.

D) Relevant signal measurement and check 43: the detection card 26 performs signal measurement on parts of the unit under test 1, and transfers a measurement signal to the display screen 11, so as to check whether damages or error signals occur.

E) Obtaining a state of the test script at the testing machine 44: the test board 25 makes the unit under test 1 to be in an OS state, and downloads another test script into the unit under test 1.

F) A function test or a power cycle 45: the detection board 26 performs a function test or a power cycle on the unit under test 1 according to the test script in Step E.

G) Uploading a result to the testing machine 46: the testing result is first displayed on the display screen 11 of the unit under test 1, and then is sent back to the testing machine 2 through the display screen 11.

In Step B to Step D, the detection board 26 tests whether the socket 10 is damaged or whether the connection between the socket 10 and the unit under test 1 is desirable, or performs a debug action.

VI) Executing an OS test of the unit under test 35: the testing machine 2 provides an OS such as WIN, DOS, Linux, or EFI for the unit under test 1 through the test board 25, such that the unit under test 1 is capable of executing the OS, and generates a testing result, and the testing machine 2 receives the testing result in Step V.

VII) Combining testing results 36: the testing machine 2 combines the testing results in Step V and Step VI.

VIII) Displaying a testing result 37: the testing machine 2 displays the summarized testing result in a report form.

In view of the above, according to the present invention, firstly, a script editor 27 creates at least one test script, a script engine 28 executes a Non-OS and an OS test according to the test script, and is electrically connected to at least one unit under test 1 through at least one test board 25 and at least one detection board 26, the testing machine 2 may execute the Non-OS test through the detection board 26, as in the test process described in Step 5. The testing machine 2 may execute an OS test through the test board 25, and then the testing machine 2 combines the testing results of the Non-OS test and the OS test for displaying. Thus, the empty board test that needs multiple stages is integrated into a test, and the state of the socket 10 is tested through the detection board 26, so the present invention can not only improve the test accuracy, but also simplify the test process, and thus the present invention has considerable convenience and applicability.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A testing method for a unit under test, comprising:
1) scanning and downloading, wherein a testing machine scans information of at least one unit under test, and creates a test script, and the test script is downloaded into the unit under test;
2) starting the unit under test, wherein a script engine executes a non-operating system (non-OS) test, generates a testing result of the non-OS test, and transfers the testing result of the non-OS test to the testing machine;
3) executing an OS test on the unit under test, wherein the script engine executes an OS test on the unit under test according to the test script, generates a testing result of the OS test, and transfers the testing result of the OS test to the testing machine;
4) combining the testing results, wherein the testing machine combines the testing result of the non-OS test and the testing result of the OS test; and
5) displaying the testing result, wherein the operation machine displays the combined testing result.

2. The testing method for a unit under test according to claim 1, before Step I, further comprising providing an initial standby power supply, wherein the at least one unit under test is electrically connected to a connection interface of the testing machine.

3. The testing method for a unit under test according to claim 2, wherein the unit under test is a main board or a circuit board,
the testing machine is a console computer or an ITCnD Command Line Interface (ITCnD CLI),
the connection interface has a general purpose input output (GPIO), a network interface card (NIC), a unit under test link port (UUT-link port), and a display interface,
the GPIO is applicable in a joint test action group (JTAG), an inter-integrated circuit (IIC), or a serial peripheral interface bus (SPI), the GPIO is electrically connected to at least one test board and at least one detection board, the test board is electrically connected to the unit under test, the detection board is electrically connected to a socket of the unit under test,
the detection board is a debug card or a dummy card,
the NIC is applicable in the Simple Network Management Protocol (SNMP), the Intelligent Platform Management Interface (IPMI), or the Telnet,
the NIC and the UUT-link port are electrically connected to the unit under test, the unit under test has a display screen, and the display screen is electrically connected to the display interface.

4. The testing method for a unit under test according to claim 3, wherein in Step I, the testing machine scans the information of the unit under test, and the script editor disposed in the testing machine creates a test script of a CLI according to the scanned information, the test script is downloaded into the unit under test through a UUT-link port, and a software control (SFC) receives the downloading result of the unit under test, and records and checks the downloading result.

5. The testing method for a unit under test according to claim 4, between Step I and Step II, further comprising starting a test board, wherein the testing machine starts the test board, the test board burns a basic input output system (BIOS) into the unit under test, and the script engine disposed in the testing machine executes the test script through the test board.

6. The testing method for a unit under test according to claim 5, between the step of starting the test board and Step III, further comprising Basic Local Alignment Search Tool (BLAST) or authentication of programmable parts, wherein the test board starts to program the parts of the unit under test and performs BLAST or authentication on the parts.

7. The testing method for a unit under test according to claim 6, wherein the non-OS test in Step II comprises:
A) a power on self test (POST), wherein the test board performs a BIOS test on the unit under test;
B) a complex programmable logic device (CPLD) diagnosis, wherein the detection card detects logic, output, and input states of the socket;
C) power debug checking, wherein the detection card performs error check on the power supply of the unit under test, and if an error is found in the power supply of the unit under test, a debug action is performed;
D) relevant signal measurement and check, wherein the detection card performs signal measurement on the parts of the unit under test, and transfers a measurement signal to the display screen, so as to check whether damages or error signals exist;
E) obtaining a state of the test script at the testing machine, wherein the test board makes the unit under test to be in an OS state, and downloads another test script into the unit under test;
F) a function test or a power cycle, wherein the detection board performs a function test or a power cycle on the unit under test according to the test script in Step E; and
G) uploading a result to the testing machine, wherein the testing result is first displayed on the display screen of the unit under test, and then is sent back to the testing machine through the display screen.

8. The testing method for a unit under test according to claim 7, wherein in Step B to Step D, the detection board tests whether the socket is damaged or whether the connection between the socket and the unit under test is desirable, or performs a debug action.

9. The testing method for a unit under test according to claim 7, wherein in Step III, the testing machine provides an OS to the unit under test through the test board, and the OS is WIN, DOS, Linux, or EFI.

10. The testing method for a unit under test according to claim 9, wherein in Step V, the combined testing result in Step IV is displayed in a report form.
